(19) United States
(12) Patent Application Publication
(10) Pub. No.: US 2026/0363515 A1
(43) Pub. Date: Nov. 19, 2026

(54) CLEANING CLOTH FOR CLEANING DEVICE AND CLEANING DEVICE

(71) Applicant: Beijing Roborock Technology Co., Ltd., Beijing (CN)

(72) Inventors: Lidong Zhao, Beijing (CN); Caiyun Hu, Beijing (CN)

(21) Appl. No.: 19/145,606

(22) PCT Filed: Dec. 21, 2023
(86) PCT No.: PCT/CN2023/140729

§ 371 Date: Jul. 3, 2025

(30) Foreign Application Priority Data
Jan. 3, 2023 (CN) 202320006372.X

(51) Int. Cl. A47L 11/40; B32B 7/06; B32B 7/12

(52) U.S. Cl. CPC A47L 11/4044; A47L 11/4069; B32B 7/06; B32B 7/12; B32B 2432/00

(57) ABSTRACT

A cleaning cloth for a cleaning device, and the cleaning apparatus. The cleaning cloth for the cleaning device comprises a cleaning layer. The cleaning layer comprises a fixed area and a plurality of movable areas, and the plurality of movable areas are arranged in a longitudinal direction of the cleaning device. The provided cleaning cloth can improve the cleaning effect of the cleaning device.

### CROSS-REFERENCE TO RELATED APPLICATION

The present disclosure is a U.S. National Stage of International Application No. PCT/CN2023/140729, filed on Dec. 21, 2023, which claims the benefit of priority to Chinese Patent Application No. 202320006372.X filed on Jan. 3, 2023, both of which are incorporated herein by reference in their entireties for all purposes.

### TECHNICAL FIELD

The present disclosure generally relates to the technical field of cleaning devices, and in particular, to a cleaning cloth for a cleaning device and a cleaning device.

### BACKGROUND

Nowadays, with the development of modern society, there is an increasing number of people focusing their lives on work. They hardly have time to do cleaning for household hygiene, while daily cleaning and maintenance of household hygiene affect people's quality of life all the time. To save time and maintain household hygiene, more and more people have begun to purchase cleaning robots to clean the inside of their houses promptly and conveniently.

The cleaning robots can automatically clean the floor in the room with a certain degree of artificial intelligence. Generally, sweeping and vacuuming methods are adopted to first collect debris from the ground into an internal waste container, followed by wiping the ground to complete the ground cleaning.

It should be noted that the information disclosed in the above background section is only used for enhancement of understanding of the background of the present disclosure and therefore may include information that does not constitute the prior art known to those of ordinary skill in the art.

### SUMMARY

According to an aspect of the present disclosure, a cleaning cloth for a cleaning device is provided. The cleaning device has a vibration cleaning function. The cleaning cloth includes: a cleaning layer. The cleaning layer includes a fixed area and a plurality of movable areas. The plurality of movable areas are distributed in a front-rear direction of the cleaning device.

According to another aspect of the present disclosure, a cleaning device is provided. The cleaning device includes:
the cleaning cloth according to any one of the above embodiments;
a wiping assembly, including a fixing plate and a plurality of movable areas of the cleaning cloth are located on the plurality of vibration plates in one-to-one correspondence with the plurality of vibration plates.

It should be understood that, both the foregoing general description and the following detailed description are exemplary and explanatory only and are not construed as limiting the present disclosure.

### BRIEF DESCRIPTION OF THE DRAWINGS

The above and other features and advantages of the present disclosure will become more apparent from the detailed description of exemplary embodiments thereof with reference to the drawings

FIG. 1 is a schematic diagram of a cleaning device according to an embodiment of the present disclosure;

FIG. 2 is a schematic diagram of the front surface of a cleaning cloth according to an embodiment of the present disclosure;

FIG. 3 is a schematic diagram of the back surface of a cleaning cloth according to an embodiment of the present disclosure;

FIG. 4 is a schematic diagram of a cleaning cloth and a wiping mechanism according to an embodiment of the present disclosure;

FIG. 5 is a schematic diagram of the front surface of a wiping mechanism according to an embodiment of the present disclosure;

FIG. 6 is a schematic diagram of the back surface of a wiping mechanism according to an embodiment of the present disclosure;

FIG. 7 is a schematic diagram of the interior of a wiping mechanism according to an embodiment of the present disclosure;

FIG. 8 is a three-dimensional schematic diagram of a vibration assembly according to an embodiment of the present disclosure;

FIG. 9 is a schematic diagram of the front surface of a vibration assembly according to an embodiment of the present disclosure;

FIG. 10 is a schematic diagram of the back surface of a vibration assembly according to an embodiment of the present disclosure;

FIG. 11 is a schematic diagram of the interior of a wiping mechanism according to another embodiment of the present disclosure;

FIG. 12 is a three-dimensional schematic diagram of a vibration assembly according to another embodiment of the present disclosure;

FIG. 13 is a schematic diagram of the front surface of a vibration assembly according to another embodiment of the present disclosure; and

FIG. 14 is a schematic diagram of the back surface of a vibration assembly according to another embodiment of the present disclosure.

### DESCRIPTION OF THE REFERENCE NUMERALS

10, wiping mechanism;
100, wiping assembly; 110, vibration plate; 111, first vibration plate; 1110, connecting groove; 1111, first notch; 1112, assembly notch; 112, second vibration plate; 1121, second notch; 120, connecting rod; 130, reset assembly; 131, fixing arm; 132, resilient arm;
200, vibration assembly; 210, vibration connecting rod; 220, vibration damping apparatus;
300, bottom plate;
400, fixing plate;
500, water discharge nozzle;
20, cleaning cloth; 21, cleaning layer; 22, adhesive layer; 221, first adhesive layer; 222, second adhesive layer; 23, guide strip;
30, cleaning device.

### DETAILED DESCRIPTION

Exemplary embodiments will now be described more comprehensively with reference to the drawings. However, the exemplary embodiments may be implemented in various forms, and should not be understood as being limited to the embodiments described herein. On the contrary, these embodiments are provided to make the present disclosure comprehensive and complete, and comprehensively convey the idea of the exemplary embodiments to those skilled in the art. The same reference numerals in the drawings indicate the same or similar structures, and thus, a detailed description thereof will be omitted.

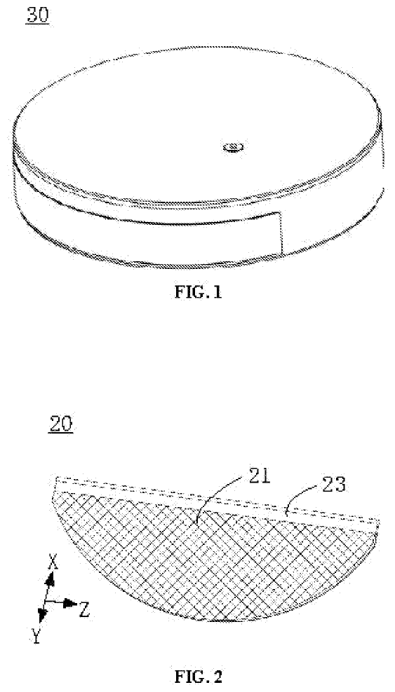

The embodiments of the present disclosure first provide a cleaning device. As shown in FIG. 1, the cleaning device 30 may be, for example, a mopping/scrubbing robot, a robot vacuum cleaner, or a window cleaning robot. The cleaning device 30 includes a wiping mechanism and a cleaning cloth, and has a vibration cleaning function.

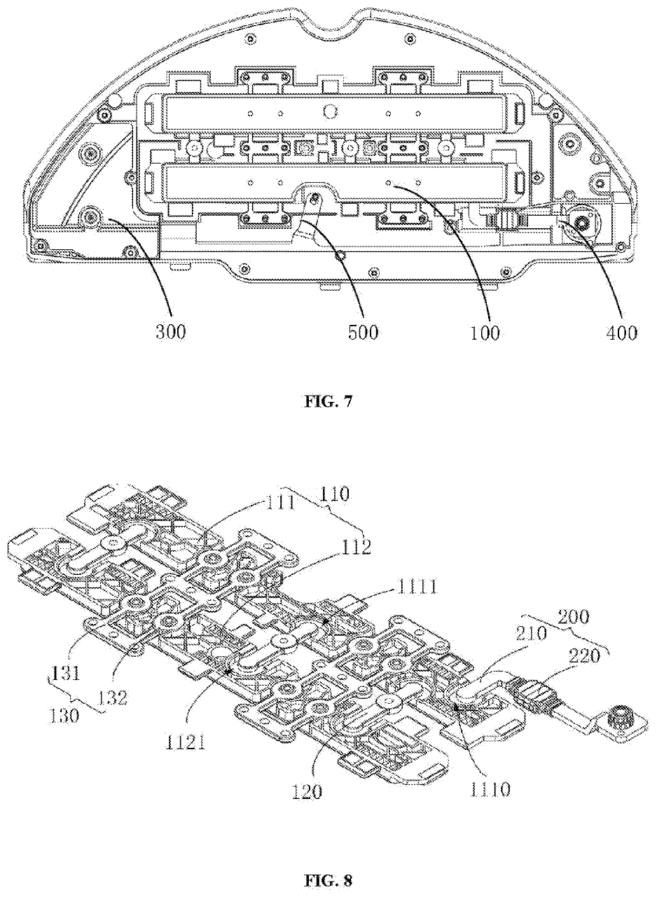

Specifically, as shown in FIGS. 4 to 8, the wiping mechanism 10 includes a wiping assembly 100 and a vibration assembly 200. The wiping assembly 100 includes a vibration plate 110 and a fixing plate 400. The vibration assembly 200 is configured to drive the vibration plate 110 to reciprocate in a preset direction relative to the fixing plate 400. The cleaning cloth 20 is configured to be attached to the wiping assembly 100 of the wiping mechanism 10, and the cleaning cloth 20 is driven to wipe a target surface by the wiping mechanism 10.

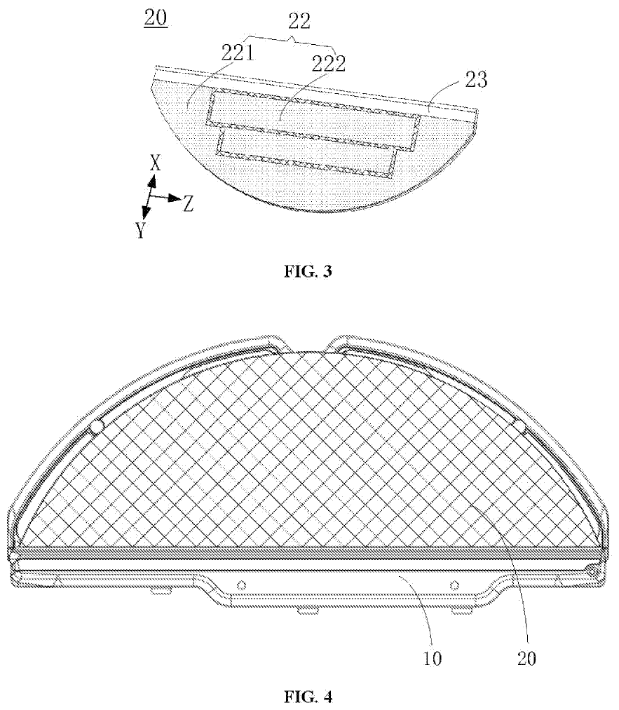

In an embodiment of the present disclosure, as shown in FIGS. 2 to 4, the cleaning cloth 20 includes: a fixed area and a plurality of movable areas. The plurality of movable areas are distributed in a front-rear direction of the cleaning device 30. The front-rear direction is a forward direction X and a backward direction Y of the cleaning device 30, and the forward direction X and the backward direction Y are two parallel directions opposite to each other.

The cleaning cloth 20 is a whole piece, an area of the cleaning cloth 20 corresponding to the vibration plate 110 is a movable area, and an area of the cleaning cloth 20 corresponding to the fixing plate 400 is a fixed area.

In the cleaning cloth 20 according to the present disclosure, the plurality of movable areas are distributed in the front-rear direction of the cleaning device 30. The front-end movable area close to the forward direction X may be enabled to work together with the vibration plate 110 to clean stains, and the front-end movable area may serve as a disintegration area to perform high-intensity preliminary treatment and disintegration of stubborn stains under the drive of the vibration plate 110. Then, follow-up consolidation may be performed by the rear movable area, and the rear movable area may serve as a consolidation area, in which targeted vibration wiping continues, thereby improving the cleaning effect of the cleaning device 30.

In an embodiment of the present disclosure, in two adjacent movable areas, an area of a movable area close to the forward direction X of the cleaning device 30 is larger than an area of a movable area away from the forward direction X. By enabling the area of the movable area close to the forward direction Y of the cleaning device 30 to be larger than the area of the movable area away from the forward direction X of the cleaning device in the two adjacent movable areas, movable areas with different areas are formed. The front-end movable area with a large area may be enabled to work together with the vibration plate 110 to clean stains, and the front-end movable area with a large area may serve as a disintegration area to perform high-intensity preliminary treatment and disintegration of stubborn stains in a large area under the drive of the vibration plate 110. Then, follow-up consolidation may be performed by the rear movable area with a small area, and the rear movable area may serve as a consolidation area, in which targeted vibration wiping within a small range continues, thereby improving the cleaning efficiency and cleaning effect of the cleaning device 30.

In the two adjacent movable areas, lengths of the two movable areas in the forward direction X may be the same, and the two movable areas are different in a width direction Z perpendicular to the forward direction X, thereby achieving different areas. Certainly, the lengths of the two movable areas in the forward direction X may also be different.

Areas of the plurality of movable areas may also be the same. Alternatively, areas of some movable areas are the same, while those of others are different, which is not limited in the present disclosure.

In an embodiment of the present disclosure, at least a part of the fixed area is located on a side of the plurality of movable areas close to a backward direction of the cleaning device. The front-end movable area with a large area is enabled to work together with the vibration plate 110 to clean stains, thereby performing high-intensity preliminary treatment and disintegration of stubborn stains in a large area under the drive of the vibration plate 110. Then, follow-up consolidation is performed by the rear movable area with a small area, enabling targeted vibration wiping within a small range to continue. Finally, the fixed area serves as a wiping area to absorb and wipe away the cleaned stains together with the cleaning solution, and thoroughly clean the ground, thereby further improving the cleaning efficiency and cleaning effect of the cleaning device 30.

In an embodiment of the present disclosure, as shown in FIGS. 2 to 4, the cleaning cloth 20 includes: a cleaning layer 21 and an adhesive layer 22. The cleaning layer 21 includes a cleaning surface and a back surface opposite to each other. The adhesive layer 22 includes a first surface and a second surface opposite to each other, the adhesive layer 22 is stacked on the cleaning layer 21, the first surface and the back surface are oppositely arranged, and the second surface of the adhesive layer 22 is configured to be attached to a target object.

The adhesive layer 22 includes a first adhesive part 221 and second adhesive parts 222 which are separated from one another. The first adhesive part 221 is located on the fixed area, and the second adhesive parts 222 are located on the movable areas. The fixed area of the cleaning layer 21 is attached to the fixing plate 400 of the cleaning device 30 through the first adhesive part 221, and the plurality of movable areas of the cleaning layer 21 are attached to the vibration plate 110 of the cleaning device 30 through the second adhesive parts 222.

In the cleaning cloth 20 according to the present disclosure, the adhesive layer 22 includes the first adhesive part 221 and the second adhesive parts 222 which are separated from one another. The first adhesive part 221 is located on the fixed area of the cleaning layer 21, and the second adhesive parts 222 are located on the movable areas of the cleaning layer 21. The cleaning cloth 20 may be connected to the fixing plate 400 of the cleaning device through the first adhesive, and the cleaning cloth 20 may be connected to the vibration plate 110 of the wiping mechanism 10 through the second adhesive parts 222, so as to achieve fixation of the cleaning cloth 20 on the cleaning device. Meanwhile, as the first adhesive part 221 and the second adhesive parts 222 are separately arranged, in the case where the vibration plate 110 of the wiping mechanism 10 vibrates relative to the fixing plate 400, the first adhesive part 221 and the second adhesive parts 222 do not interfere with one another, thereby avoiding interference during the vibration of the vibration plate 110, and further improving the cleaning effect.

In an embodiment of the present disclosure, the wiping assembly 100 includes a plurality of vibration plates 110, the cleaning layer 21 includes a plurality of movable areas, and the plurality of movable areas are in one-to-one correspondence with the plurality of vibration plates 110. The adhesive layer 22 includes a plurality of separate second adhesive parts 222, and each movable area corresponds to at least one second adhesive part 222. After the cleaning cloth 20 is fixed on the wiping mechanism 10, the plurality of second adhesive parts 222 are located on the plurality of vibration plates 110. With the plurality of vibration plates 110, the cleaning layer 21 is enabled to include the plurality of movable areas, such that the areas of the movable areas of the cleaning layer 21 can be further increased, thereby improving the cleaning effect of the cleaning layer 21.

The cleaning layer 21 may include, for example, two movable areas. Through the arrangement of the two movable areas, the overall size of the cleaning cloth 20 can be effectively utilized, enabling each functional area to have a sufficient area to effectively perform its function. Certainly, the cleaning layer 21 may include, for example, three, four, or more movable areas, which is not limited in the present disclosure.

One, two, or more second adhesive parts 222 may be correspondingly disposed on each movable area, and the adhesion to the vibration plate 110 of the wiping mechanism 10 is achieved through one or more second adhesive parts 222 on the movable areas.

In the case where one second adhesive part 222 is disposed on each movable area, the shape and dimension of the second adhesive part 222 are consistent or substantially consistent with the shape and dimension of the vibration plate 110, so as to ensure connection reliability between the movable area and the vibration plate 110. For example, in the case where the vibration plate 110 is in a rectangular shape, the second adhesive part 222 is also in a matching rectangular shape, and an edge of the second adhesive part 222 and an edge of the vibration plate 110 coincide or substantially coincide after adhesion is completed.

In the case where a plurality of second adhesive part 222 are disposed on each movable area and the plurality of second adhesive part 222 may be closely arranged, the shape and dimension of the integral adhesive part formed by the plurality of closely arranged second adhesive parts 222 may be consistent or substantially consistent with the shape and dimension of the vibration plate 110, so as to ensure connection reliability between the movable area and the vibration plate 110. For example, in the case where the vibration plate 110 is in a rectangular shape, the integral adhesive part formed by the plurality of closely arranged second adhesive parts 222 is also in a matching rectangular shape, and an edge of the integral adhesive part formed by the plurality of closely arranged second adhesive parts 222 and an edge of the vibration plate 110 coincide or substantially coincide after adhesion is completed. Certainly, the plurality of second adhesive parts 222 may also be arranged at specific intervals. The shapes and dimensions of the plurality of second adhesive parts 222 may be the same or different.

In an embodiment of the present disclosure, the number of the second adhesive parts 222 is consistent with the number of the movable areas. That is, the number of the second adhesive parts 222 is consistent with the number of the vibration plates 110 on the wiping mechanism 10, and the plurality of second adhesive parts 222 are located on the plurality of movable areas in one-to-one correspondence with the plurality of movable areas. By enabling the plurality of second adhesive parts 222 to be located on the plurality of movable areas in one-to-one correspondence with the plurality of movable areas, one vibration plate 110 is enabled to correspond to one second adhesive part 222, facilitating adhesion of the cleaning cloth 20 to the vibration plates 110 of the wiping mechanism 10 through the second adhesive parts 222.

The shapes and dimensions of the vibration plates 110 on the wiping mechanism 10 may be the same or different, and the shapes and dimensions of the plurality of second adhesive parts 222 located on different vibration plates 110 may also be the same or different.

In an embodiment of the present disclosure, the second surface of the adhesive layer 22 includes a hook surface of a hook and loop fastener; or the second surface of the adhesive layer 22 includes a loop surface of a hook and loop fastener; or the second surface of the adhesive layer 22 includes a hook surface and a loop surface of a hook and loop fastener.

In the case where the second surface of the adhesive layer 22 is a hook surface of a hook and loop fastener, that is, in the case where the second surfaces of the first adhesive part 221 and the second adhesive parts 222 are all hook surfaces of a hook and loop fastener, loop surfaces of the hook and loop fastener may be provided on the surfaces of the vibration plate 110 and the fixing plate 400 of the wiping mechanism 10, enabling the first adhesive part 221 to be detachably attached to the fixing plate 400, and the second adhesive parts 222 to be detachably attached to the vibration plate 110.

In the case where the second surface of the adhesive layer 22 is a loop surface of a hook and loop fastener, that is, in the case where the second surfaces of the first adhesive part 221 and the second adhesive parts 222 are all loop surfaces of a hook and loop fastener, hook surfaces of the hook and loop fastener may be provided on the surfaces of the vibration plate 110 and the fixing plate 400 of the wiping mechanism 10, enabling the first adhesive part 221 to be detachably attached to the fixing plate 400, and the second adhesive parts 222 to be detachably attached to the vibration plate 110.

In the case where the second surface of the adhesive layer 22 includes a hook surface and a loop surface of a hook and loop fastener, for example, in the case where the second surface of the first adhesive part 221 is a hook surface of a hook and loop fastener, and the second surfaces of the second adhesive parts 222 are loop surfaces of a hook and loop fastener, a loop surface of the hook and loop fastener may be provided on the surface of the fixing plate 400 of the cleaning device, and hook surfaces of the hook and loop fastener may be provided on the surface of the vibration plate 110, enabling the first adhesive part 221 to be detachably attached to the fixing plate 400, and the second adhesive parts 222 to be detachably attached to the vibration plate 110; or in the case where the second surface of the first adhesive part 221 is a loop surface of a hook and loop fastener, and the second surfaces of the second adhesive parts 222 are hook surfaces of a hook and loop fastener, a hook surface of the hook and loop fastener may be provided on the surface of the fixing plate 400 of the cleaning device, and loop surfaces of the hook and loop fastener may be provided on the surface of the vibration plate 110, enabling the first adhesive part 221 to be detachably attached to the fixing plate 400, and the second adhesive parts 222 to be detachably attached to the vibration plate 110; or in the case where the second surface of the first adhesive part 221 includes both a hook surface and a loop surface of a hook and loop fastener, a hook surface and a loop surface of a hook and loop fastener may be provided on the surface of the fixing plate 400 of the cleaning device, enabling the first adhesive part 221 to be detachably attached to the fixing plate 400; in the case where the second surfaces of the second adhesive parts 222 include both hook surfaces and loop surfaces of a hook and loop fastener, hook surfaces and loop surfaces of a hook and loop fastener may be provided on the surface of the vibration plate 110 of the wiping mechanism 10, enabling the second adhesive parts 222 to be detachably attached to the vibration plate 110; or in the case where hook surfaces of a hook and loop fastener are provided on a part of the second surfaces of the plurality of second adhesive parts 222, and loop surfaces of a hook and loop fastener are provided on another part of the second surfaces of the plurality of second adhesive parts, hook surfaces of the hook and loop fastener may be provided on a part of the surfaces of the plurality of vibration plates 110 of the cleaning device, and loop surfaces of the hook and loop fastener are provided on another part of the surfaces of the plurality of vibration plates, enabling the plurality of second adhesive parts 222 to be detachably attached to the plurality of vibration plates 110 through the hook and loop fasteners.

In an embodiment of the present disclosure, the adhesive layer 22 is stitched to the cleaning layer 21. The adhesive layer 22 is stitched to the cleaning layer 21 for fixation, facilitating a fixed connection between the adhesive layer 22 and the cleaning layer 21. After the service life of the cleaning layer 21 expires, the cleaning layer 21 is easily separated from the adhesive layer 22, and the adhesive layer 22 can be reused. Certainly, the adhesive layer 22 and the cleaning layer 21 may also be connected by means of gluing, snap-fit connection, or the like, which is not limited in the present disclosure.

In an embodiment of the present disclosure, the material of the cleaning layer 21 includes polyester and chinlon, and the mass ratio of the polyester to the chinlon is 7:2-7:4, for example, 7:2, 7:3, or 7:4, which will not be enumerated in the present disclosure. As common stains in life are mostly water-soluble stains, a large amount of water facilitates stain dissolution, thereby improving the cleaning effect. The water content of the cleaning cloth 20 can be increased by enabling the mass ratio of polyester to chinlon to be 7:2-7:4 and changing the material of the cleaning cloth 20. Certainly, the mass ratio of polyester to chinlon may also be less than 7:2 or greater than 7:4, which is not limited in the present disclosure.

In an embodiment of the present disclosure, the cleaning cloth 20 further includes: a guide strip 23. The guide strip 23 is connected to the cleaning layer 21, and the guide strip 23 is configured to fix the cleaning cloth 20. The guide strip 23 is parallel to a width direction Z of a second fixed part 222. As the cleaning cloth 20 itself is soft and prone to wrinkling, by arranging the guide strip 23, the guide strip 23 is fixed on the cleaning device to fix one side of the cleaning cloth 20, thereby preventing a side edge of the cleaning cloth 20 from contracting inward to cause the cleaning cloth 20 to wrinkle, improving the flatness of the cleaning cloth 20, and improving the cleaning effect of the cleaning cloth 20.

The cleaning layer 21 may be in a circular segment shape, and the guide strip 23 is disposed on a straight edge of the cleaning layer 21. The guide strip 23 may be made of a rubber material or a metal material, and the guide strip 23 may be in a flat strip shape.

A snap-fit structure matching a fixed structure on the cleaning device is disposed on the guide strip 23. For example, a protruding part is disposed on one side of the guide strip 23 distal to the cleaning layer 21, and the protruding part is located in a clamping groove formed by the fixed structure to limit the guide strip 23, thereby fixing the cleaning layer 21. Certainly, in the case where the guide strip 23 is made of a metal material, the guide strip 23 may be fixed to the cleaning device through magnetic attraction. A fixing manner of the guide strip 23 on the cleaning device is not limited in the present disclosure, and any solution that can achieve the same technical effect falls within the protection scope of the present disclosure.

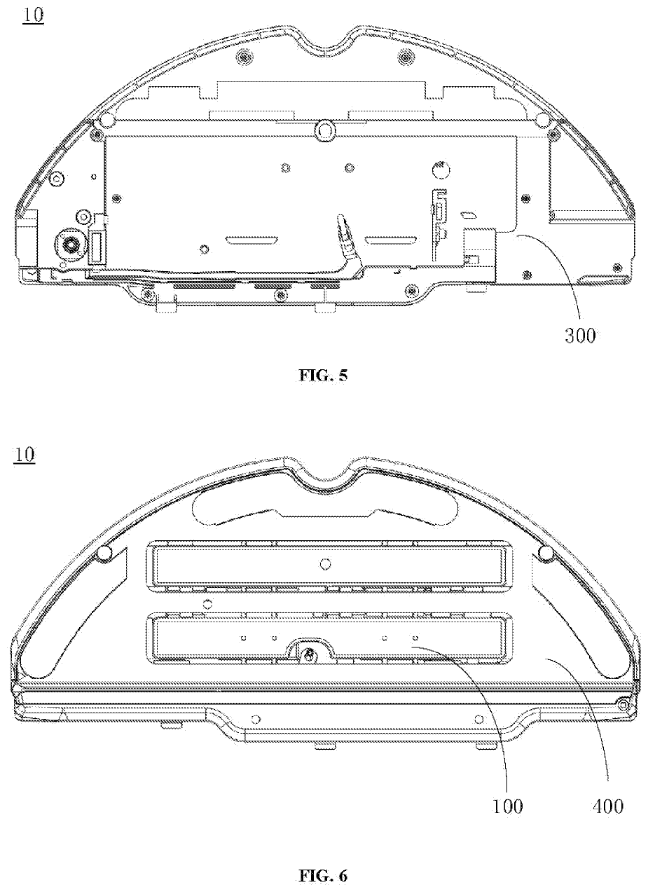

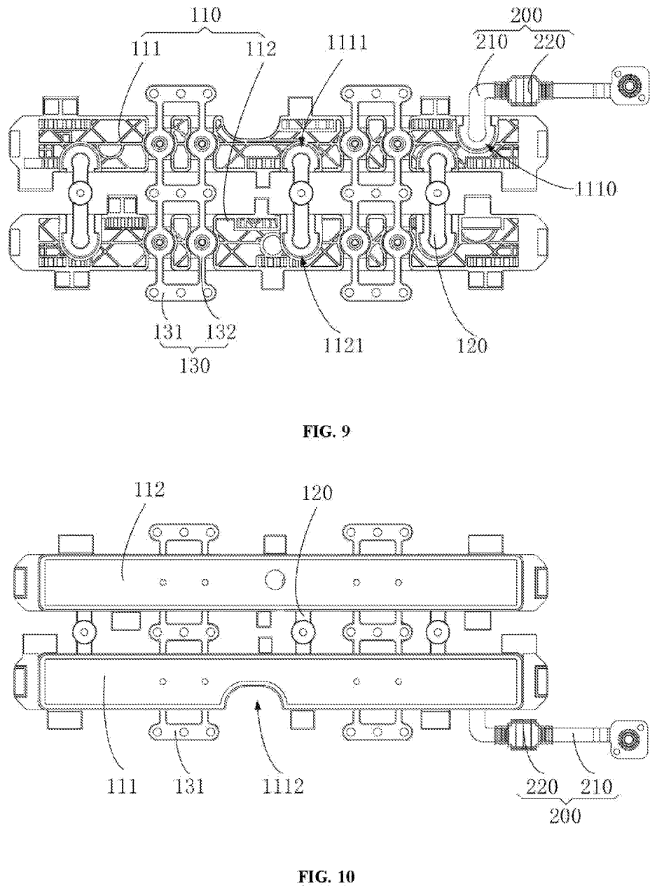

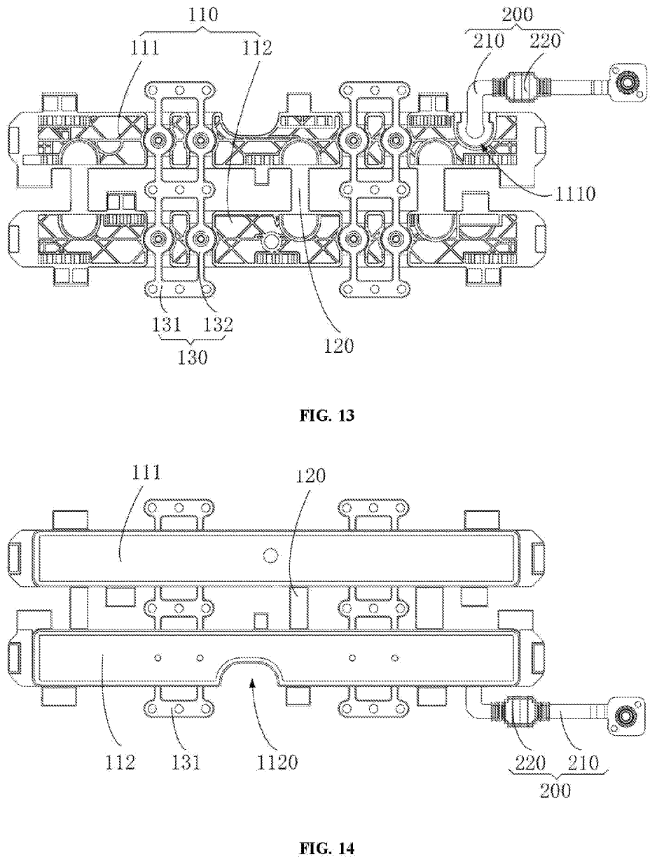

In an embodiment of the present disclosure, as shown in FIGS. 5 to 14, the wiping assembly 100 includes a plurality of vibration plates 110. A connecting rod 120 is provided between two adjacent vibration plates 110, and the two adjacent vibration plates 110 are capable of moving synchronously through the connecting rod 120. A connecting groove 1110 is formed on at least one of the plurality of vibration plates 110. The plurality of vibration plates 110 are connected, where a connecting groove 1110 is formed on at least one of the plurality of vibration plates 110. The vibration assembly 200 includes a vibration device and a vibration connecting rod 210. One end of the vibration connecting rod 210 is connected to the vibration device, and another end of the vibration connecting rod is located in the connecting groove 1110. The vibration assembly 200 is configured to drive the vibration connecting rod 210 to reciprocate in a preset direction; and the vibration connecting rod 210 is configured to abut against a side wall of the connecting groove 1110 in the case of reciprocating in the preset direction to drive the plurality of vibration plates 110 to reciprocate.

In the wiping mechanism 10 according to the present disclosure, the wiping assembly 100 includes a plurality of vibration plates 110, the vibration assembly 200 is capable of driving the vibration connecting rod 210 to reciprocate in a preset direction, and the vibration connecting rod 210 abuts against a side wall of a connecting groove 1110 in the case of reciprocating in a preset direction, thereby driving the vibration plate 110 in which the connecting groove 1110 is located to reciprocate. As the connecting rod 120 is provided between two adjacent vibration plates 110, in the case where one vibration plate 110 reciprocates, another vibration plates 110 are capable of being driven to reciprocate synchronously through the connecting rod 120. In the case where the frequency of the reciprocating motion is large, the reciprocating motion of the vibration plate 110 can be regarded as high-frequency vibration, thereby increasing the vibration area of the wiping mechanism 10, and improving the cleaning efficiency and cleaning effect of the wiping mechanism 10.

In an embodiment of the present disclosure, as shown in FIGS. 6 to 14, the wiping assembly 100 includes two vibration plates, i.e., a first vibration plate 111 and a second vibration plate 112. The shape and dimension of the first vibration plate 111 are consistent or substantially consistent with the shape and dimension of the second vibration plate 112. Certainly, the wiping assembly 100 may further include three, four, or more vibration plates 110, which is not limited in the present disclosure. The specific details of the wiping mechanism will be described in detail below in the present disclosure with reference to the case that the wiping assembly 100 includes two vibration plates.

Specifically, as shown in FIG. 5, the wiping mechanism 10 further includes: a bottom plate 300. The wiping assembly 100 and the vibration assembly 200 are assembled on the bottom plate 300, and the vibration device is fixedly connected to the bottom plate 300. The plane where the vibration plate 110 reciprocates is parallel or substantially parallel to the plane where the bottom plate 300 is located. The vibration plate 110 is spaced apart from the bottom plate 300. Two vibration plates 110 are connected to the bottom plate 300 through a limiting structure, and the limiting structure is configured to limit a plurality of movements of the two vibration plates 110 in a thickness direction of the bottom plate 300, enabling the vibration plates 110 to reciprocate on the plane parallel or substantially parallel to the bottom plate 300.

The limiting structure includes limiting arms and limiting parts, and limiting grooves are formed on the limiting parts. Illustratively, limiting arms are disposed on two opposite sides of the first vibration plate 111 and the second vibration plate 112, limiting parts are disposed on the bottom plate 300, and the limiting arms are located in the limiting grooves, thereby limiting the movement of the plurality of vibration plates 110 in the thickness direction of the bottom plate 300. Alternatively, limiting parts are disposed on two opposite sides of the first vibration plate 111 and the second vibration plate 112, limiting arms are disposed on the bottom plate 300, and the limiting arms are located in the limiting grooves, thereby limiting the movement of the plurality of vibration plates 110 in the thickness direction of the bottom plate 300. Alternatively, limiting arms are disposed on the first vibration plate 111, limiting parts are disposed on the second vibration plate 112, limiting parts and limiting arms are disposed on the bottom plate 300, and the limiting arms are located in the limiting grooves, thereby limiting the movement of the plurality of vibration plates 110 in the thickness direction of the bottom plate 300. The limiting groove formed on the limiting part enables the movement of the limiting arm in the case where the vibration plate 110 reciprocates, and does not hinder the limiting arm. Through the adjustment of the height of the limiting groove in the thickness direction of the bottom plate 300, the size of the clearance between the vibration plate 110 and the bottom plate 300 can be adjusted.

The limiting arm may be in a flat plate shape, the limiting part may be in a rectangular annular shape, and the limiting arm is in surface contact with the limiting part. In the case where the vibration plate 110 reciprocates, the cooperation between the limiting arm and the limiting part can serve to guide the vibration plate 110, thereby improving the stability and reliability of the vibration plate 110 during high-frequency vibration.

The limiting arm and the vibration plate 110 or the bottom plate 300 are formed as an integrated structure, and the limiting part and the bottom plate 300 or the vibration plate 110 or the bottom plate 300 are formed as an integrated structure, so as to improve the strength of the limiting structure. Certainly, the limiting arm may be bonded, welded, snap-fitted, riveted, or the like to the vibration plate 110 or the bottom plate 300, and the limiting part may be bonded, welded, snap-fitted, riveted, or the like to the bottom plate 300 or the vibration plate 110 or the bottom plate 300, which is not limited in the present disclosure.

In an embodiment of the present disclosure, as shown in FIGS. 6 to 10, two adjacent vibration plates 110 move in opposite directions during reciprocation. By enabling the two adjacent vibration plates 110 to move in opposite directions during reciprocation, the forces generated by the left and right vibrations are balanced in the vibration process and the stability of the wiping mechanism is improved in the case where the vibration area of the wiping mechanism is increased and the cleaning efficiency and cleaning effect of the wiping mechanism are improved.

A rotation shaft is disposed on the bottom plate 300, a through hole is formed on the middle part of the connecting rod 120, and the connecting rod 120 is assembled on the rotation shaft on the bottom plate 300 through the through hole, thereby achieving the rotation relative to the bottom plate 300. First notches 1111 are formed on the first vibration plate 111, and second notches 1121 are formed on the second vibration plate 112. Both ends of the connecting rod 120 are located in the notches of two adjacent vibration plates 110 respectively. In the case where one vibration plate 110 of the two adjacent vibration plates 110 reciprocates, the side walls of the notches abut against the connecting rod 120 to drive the connecting rod 120 to swing, thereby driving the other vibration plate 110 to reciprocate in an opposite direction through the connecting rod 120. For example, in the case where the first vibration plate 111 reciprocates, the side wall of the first notch 1111 abuts against the connecting rod 120 to drive the connecting rod 120 to swing, and further the other end of the connecting rod 120 abuts against the second notch 1121 of the second vibration plate 112, thereby driving the second vibration plate 112 to reciprocate in an opposite direction.

Illustratively, both ends of the connecting rod 120 are only located in the first notch 1111 and the second notch 1121 respectively, and are not connected to the first vibration plate 111 and the second vibration plate 112. The end parts of the connecting rod 120 abut against the first vibration plate 111 and the second vibration plate 112 to transmit the acting force therebetween. This facilitates the assembly of the first vibration plate 111 and the second vibration plate 112 with the connecting rod 120, and also facilitates the maintenance.

Illustratively, in the case where both ends of the connecting rod 120 are located in the first notch 1111 and the second notch 1121, the both ends of the connecting rod 120 are rotatably connected to the first vibration plate 111 and the second vibration plate 112, respectively. By forming connecting holes on the end parts of the connecting rod 120 and arranging rotation posts on the first vibration plate 111 and the second vibration plate 112, the rotation posts are sleeved with the connecting rod 120 through the connecting holes, thereby achieving the rotatable connection of the connecting rod 120 to the first vibration plate 111 and the second vibration plate 112. Alternatively, connecting holes are formed on the first vibration plate 111 and the second vibration plate 112, rotation posts are arranged at the end parts of the connecting rod 120, and the connecting rod 120 extends into the connecting holes through the rotation posts, thereby achieving the rotatable connection to the first vibration plate 111 and the second vibration plate 112.

Illustratively, three connecting rods 120 are provided between the first vibration plate 111 and the second vibration plate 112. In the case where the first vibration plate 111 reciprocates, the three connecting rods 120 are capable of being driven to simultaneously swing, thereby driving the second vibration plate 112 to reciprocate simultaneously through the three connecting rods 120. As there is a clearance between the end part of the connecting rod 120 and the side wall of the notch, the second vibration plate 112 exhibits a short delay time relative to the first vibration plate 111, and thus the first vibration plate 111 and the second vibration plate 112 may be considered to move synchronously. Certainly, one, two, four, or more connecting rods 120 may be provided between the first vibration plate 111 and the second vibration plate 112, which is not limited in the present disclosure.

In an embodiment of the present disclosure, as shown in FIGS. 11 to 14, a plurality of vibration plates 110 move in the same direction during reciprocation. By enabling two adjacent vibration plates 110 to move in the same direction during reciprocation, the vibration area of the wiping mechanism is increased, thereby improving the cleaning efficiency and cleaning effect of the wiping mechanism.

The two adjacent vibration plates 110 are fixedly connected through a connecting rod 120, that is, the first vibration plate 111 and the second vibration plate 112 may move completely synchronously without delay. Both ends of the connecting rod 120 may be connected to the first vibration plate 111 and the second vibration plate 112 by bonding, welding, snap-fitting, riveting, or the like to facilitate the assembly and maintenance of the first vibration plate 111 and the second vibration plate 112. Certainly, the connecting rod 120 and the first vibration plate 111 as well as the second vibration plate 112 may be formed as an integrated structure to improve the structural strength of the vibration assembly 200 and ensure the completely synchronous movement of the first vibration plate 111 and the second vibration plate 112.

Illustratively, three connecting rods 120 are provided between the first vibration plate 111 and the second vibration plate 112. In the case where the first vibration plate 111 reciprocates, the second vibration plate 112 is capable of being driven to reciprocate simultaneously through the three connecting rods 120. Certainly, one, two, four, or more connecting rods 120 may be provided between the first vibration plate 111 and the second vibration plate 112, which is not limited in the present disclosure.

Specifically, as shown in FIGS. 8, 9, 12, and 13, the wiping mechanism further includes: a reset assembly 130. The reset assembly 130 includes fixing arms 131 and resilient arms 132. The fixing arm 131 is fixedly connected to the bottom plate 300, the resilient arm 132 is connected to the fixing arm 131, and the resilient arm 132 is located on the vibration plate 110. In the case where the vibration plate 110 is located at an initial position, the resilient arm 132 is in a free state, and in the case where the vibration plate 110 moves away from the initial position to reciprocate, the vibration plate can abut against the resilient arm 132 and drive the resilient arm 132 to deform. Through the arrangement of the reset assembly 130, in one aspect, the first vibration plate 111 and the second vibration plate 112 are limited in the reciprocating direction; in another aspect, with the resilient arm 132, the movement speeds of the first vibration plate 111 and the second vibration plate 112 can be increased in a phase in which the resilient arm 132 recovers from elastic deformation during reciprocation, thereby improving the wiping effects of the first vibration plate 111 and the second vibration plate 112.

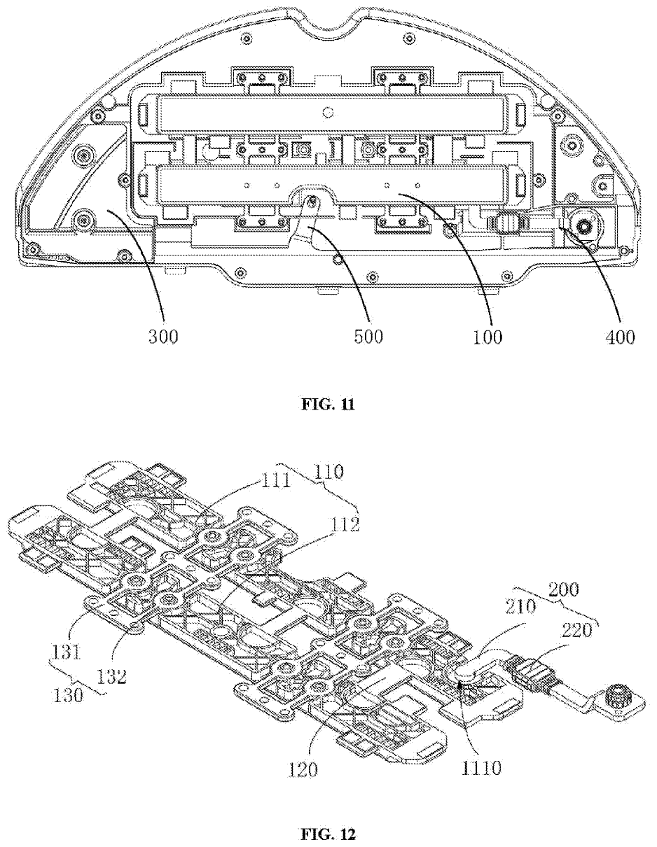

As shown in FIGS. 8 and 12, the first vibration plate 111 and the second vibration plate 112 are provided with two reset assemblies 130, and one reset assembly 130 simultaneously acts on both the first vibration plate 111 and the second vibration plate 112. Mounting holes are formed on the resilient arms 132 of the reset assembly 130, and bosses are disposed on the first vibration plate 111 and the second vibration plate 112. After the reset assembly 130 is assembled on the first vibration plate 111 and the second vibration plate 112, the protrusions are inserted into the mounting holes. In the case where the first vibration plate 111 and the second vibration plate 112 reciprocate, the bosses on the first vibration plate 111 and the second vibration plate 112 drive the resilient arms 132 to deform. One reset assembly 130 includes two parallel resilient arms 132, the two resilient arms 132 are connected through three fixing arms 131, and the three fixing arms 131 are located in the middle area between the first vibration plate 111 and the second vibration plate 112 and two opposite side areas of the first vibration plate and the second vibration plate, respectively. The fixing arms 131 may be fixedly connected to a fixing plate 400 through screws or the like.

The reset assembly 130 may be of an integrated frame structure, and the reset assembly 130 may be made of a plastic material or a metal material with good elastic performance.

As shown in FIGS. 8 and 12, the two reset assemblies 130 and the three connecting rods 120 are alternately arranged in the reciprocating direction, so as to improve the acting effect of the reset assemblies 130 on the first vibration plate 111 and the second vibration plate 112. Certainly, the two reset assemblies 130 may also be arranged adjacent to each other, which is not limited in the present disclosure.

The bottom plate 300 is provided with first limiting blocks at both ends of the first vibration plate 111, and the bottom plate 300 is provided with a stroke range of the reciprocation of the first vibration plate 111 defined by the first limiting blocks. The bottom plate 300 is provided with second limiting blocks at both ends of the second vibration plate 112, and the stroke range of the reciprocation of the second vibration plate 112 is defined by the second limiting blocks. The first limiting block and the second limiting block may be elastic rubber blocks to function as buffers.

Specifically, as shown in FIGS. 10 and 14, an assembly notch 1112 is formed on the first vibration plate 111, and a water discharge nozzle 200 is provided near the assembly notch 1112 of the first vibration plate 111. The water discharge nozzle 200 is configured to be connected to a water discharge apparatus through a hose, and water flowing out of the water discharge apparatus flows to the first vibration plate 111 and the second vibration plate 112 through the water discharge nozzle 200 to wet wiping cloths of the first vibration plate 111 and the second vibration plate 112, or to inject a cleaning solution into the wiping cloths of the first vibration plate 111 and the second vibration plate 112, thereby improving the cleaning effect.

One water discharge nozzle may be provided, or a plurality of water discharge nozzles may be provided. That is, the assembly notch 1112 is also formed on the second vibration plate 112, and the water discharge nozzle is provided near the assembly notch 1112 of the second vibration plate 112. Water is discharged to the first vibration plate 111 and the second vibration plate 112 through the plurality of water discharge nozzles, thereby improving the uniformity of water discharge, and enabling the wiping cloths on the first vibration plate 111 and the second vibration plate 112 to be uniformly wetted. The water discharge apparatus may be connected to a cleaning solution outlet of a water tank, and the cleaning solution may flow to the water discharge apparatus through the cleaning solution outlet of the water tank. The power/flow rate of the water discharge apparatus is adjustable, and the water discharge amount may be controlled according to actual needs.

Specifically, the surfaces of the plurality of vibration plates 110 are each provided with an independent hook fastener. That is, the first vibration plate 111 and the second vibration plate 112 are each provided with an independent hook fastener. By providing the first vibration plate 111 and the second vibration plate 112 each with an independent hook fastener, the attachment of the wiping cloths to the first vibration plate 111 and the second vibration plate 112 is facilitated, and the wiping cloths are directly attached to the hook surfaces of the hook and loop fasteners. In addition, through the gap formed by the hook fasteners, the water discharge to the wiping cloths on the first vibration plate 111 and the second vibration plate 112 through the plurality of water discharge nozzles is facilitated, enabling the wiping cloths on the first vibration plate 111 and the second vibration plate 112 to be uniformly wetted. Besides, by attaching the wiping clothes to the hook surfaces of the hook and loop fasteners, the cleaning and replacement of the wiping cloths is facilitated.

Specifically, as shown in FIG. 6, the fixing plate 400 and the bottom plate 300 fit together to form an accommodating space, and the vibration assembly 200 is disposed in the accommodating space. Wiping windows are disposed on the fixing plate 400, the first vibration plate 111 and the second vibration plate 112 are exposed from the wiping windows, and the first vibration plate 111 and the second vibration plate 112 are located on the same plane as the fixing plate 400, so as to form a wiping surface by the surfaces of the first vibration plate 111, the second vibration plate 112, and the fixing plate 400 together, that is, the surface of the fixing plate 400 may also be provided with a hook fastener for attaching a wiping cloth.

The size of the wiping window is required to ensure a smooth movement of the first vibration plate 111 and the second vibration plate 112 during reciprocation. The shape of the wiping window may match the shape of the structure formed by the cooperation of the first vibration plate 111 and the second vibration plate 112, so as to control the size of the gap between the wiping window and the first vibration plate 111 and the gap between the wiping window and the second vibration plate 112, thereby preventing foreign matters on the surface to be wiped from entering the interior of the wiping mechanism through the gaps.

Specifically, the vibration assembly 200 includes a vibration device and a vibration connecting rod 210. The vibration device may be a motor and outputs power through an output shaft of the motor. The output shaft of the motor is connected to a driving wheel, and the driving wheel is of an asymmetric structure. The vibration connecting rod 210, through connection to the output shaft of the motor via the driving wheel, reciprocates with the asymmetric rotation of the driving wheel, thereby driving the plurality of vibration plates 110 to reciprocate.

The vibration connecting rod 210 includes a first segment and a second segment. The first segment and the second segment are of an L shape. The first segment of the vibration connecting rod 210 is connected to the driving wheel and the second segment, such that the vibration connecting rod 210 extends to a preset position. The extension direction of the first segment is perpendicular to the extension direction of the second segment, such that the reciprocating direction of the vibration connecting rod 210 is substantially perpendicular to the advancing direction of the machine.

The first segment of the vibration connecting rod 210 is sleeved with a vibration damping apparatus 220. The vibration damping apparatus 220 serves to reduce the vibration and jitter caused by the motion driven by the driving wheel, such that the vibration connecting rod 210 vibrates stably within the range of motion. The vibration damping apparatus 220 is made of a soft material, optionally a rubber structure. In another aspect, the vibration damping apparatus 220 can also protect the vibration connecting rod 210 from being damaged due to collision with other components.

The rotation speed of the motor may be adjusted according to the operating environment of the wiping mechanism, and thus the preset reciprocating period of the reciprocation of the vibration plate 110 is adjusted, that is, the vibration frequency of the vibration plate 110 is adjusted to achieve different cleaning effects. For example, in the case where the wiping mechanism operates on flat ground, the preset reciprocating period may be automatically and dynamically adjusted to be long, and the water volume of the water pump may be automatically and dynamically adjusted to be small; in the case where the automatic cleaning device operates on less flat ground, the preset reciprocating period may be automatically and dynamically adjusted to be short, and the water volume of the water pump may be automatically and dynamically adjusted to be large, so as to achieve a better cleaning effect.

Specifically, the cleaning device 30 may further include a mobile platform, a sensing system, a control system, a driving system, a cleaning module, a power system, and a human-machine interaction system.

The mobile platform may be an autonomous mobile platform or a non-autonomous mobile platform. The autonomous mobile platform can automatically and adaptively make an operational decision based on an unexpected environment-related input, and the non-autonomous mobile platform can execute an established procedure or operate according to a certain logic.

The sensing system includes sensing apparatuses such as a position determining apparatus located above the mobile platform, a buffer located in a forward part of the mobile platform, a cliff sensor and an ultrasonic sensor located at the bottom of the mobile platform, an infrared sensor, a magnetometer, an accelerometer, a gyroscope, and an odometer, to provide various position information and motion status information of the machine to the control system. Cliff sensors are disposed at the bottom of the mobile platform and on the front and back of the driving wheel assembly, and the cliff sensors are configured to prevent the automatic cleaning device from falling off when reversing, thereby preventing damage to the automatic cleaning device. The position determining apparatus includes, but is not limited to, a camera and a laser ranging apparatus. The components in the sensing system may operate independently, or may operate together to more accurately perform the target function. By identifying the surface to be cleaned through the cliff sensors and the ultrasonic sensor, the physical properties of the surface to be cleaned, including a surface material, a degree of cleanliness, and the like can be determined, and the properties may be determined more accurately in combination with a camera, a laser ranging apparatus, and the like. In addition, a buffer is disposed at the forward part of the mobile platform. The buffer detects an object in the travel path of the automatic cleaning device via a sensor system, such as an infrared sensor, and the automatic cleaning device may pass by the object detected by the buffer.

The control system is disposed on a main circuit board in the mobile platform, and includes a computing processor, such as a central processing unit or an application processor, that communicates with a non-transitory memory (such as a hard disk, a flash memory, or a random access memory). The application processor is configured to receive environmental information sensed by a plurality of sensors and transmitted from the sensing system, draw a real-time map of an environment in which the automatic cleaning device is located by using a positioning algorithm based on obstacle information fed back by the laser ranging apparatus, etc., autonomously determine a travel path based on the environmental information and the environmental map, and then control the driving system to perform operations such as traveling forward, traveling rearward, and steering according to the autonomously determined travel path.

The driving system includes a drive motor, a driving wheel assembly, and a steering assembly. The drive motor provides power for rotation of the driving wheel assembly and the steering assembly.

The power system includes a rechargeable battery. The rechargeable battery may be connected to a charging control circuit, a battery pack charging temperature detection circuit, and a battery undervoltage monitoring circuit. The charging control circuit, the battery pack charging temperature detection circuit, and the battery undervoltage monitoring circuit are then connected to a single-chip microcomputer control circuit.

The human-machine interaction system includes a button on a host panel for a user to select a function, and may further include a display screen and/or an indicator light and/or a speaker, where the display screen, the indicator light, and the speaker show a current state of the machine or function options to the user, and may further include a mobile phone client program. For a path navigation type cleaning device, a mobile phone client may show a map of an environment in which the device is located and a location of the machine to the user, providing the user with richer and more user-friendly function options.

Illustratively, the cleaning device provided by the present disclosure may be in a circular shape as a whole, and the wiping mechanism may be in a circular segment shape. The wiping mechanism 10 and the cleaning device body may be of a quick-release connection structure, thereby facilitating the assembly and maintenance of the wiping mechanism 10. Certainly, the cleaning device as a whole may be in an elliptical shape, a rectangular shape, an irregular shape, or the like, which is not limited in the present disclosure.

In the embodiments of the present disclosure, unless otherwise specified, the term “a plurality of” means two or more. Terms such as “mount”, “connect”, “link”, and “fix” should be understood in a broad sense. For example, “connect” may refer to a fixed connection, a detachable connection, or an integral connection, and “link” may refer to a direct linkage, or an indirect linkage by means of an intermediate medium. For those of ordinary skill in the art, the specific meanings of the above terms in the embodiments of the present disclosure can be interpreted according to specific conditions.

In the description of the present disclosure, it should be understood that terms such as “upper”, “lower”, and the like indicating directional or positional relationships are based on the directional or positional relationships shown in the drawings. They are merely for the convenience of describing the embodiments of the present disclosure and simplifying the description, and are not intended to indicate or imply that the devices or units referred to must have specific directions or be constructed and operated in specific directions. Therefore, these terms should not be construed as limitations on the embodiments of the present disclosure.

In the description of the specification, the description of the term “one embodiment” means that specific features, structures, materials, or characteristics described in connection with the embodiment or example are included in at least one embodiment or example of the embodiments of the present disclosure. In the specification, the schematic description of the above terms does not necessarily refer to the same embodiment or example. Moreover, the specific features, structures, materials, or characteristics described may be combined in a suitable manner in any one or more embodiments or examples.

The above are only preferred embodiments of the present disclosure, and are not intended to limit the present disclosure. For those skilled in the art, the present disclosure can be modified and varied. Any modification, equivalent replacement, improvement, and the like made within the spirit and principle of the present disclosure shall all fall within the protection scope of the present disclosure.

1. A cleaning cloth for a cleaning device, wherein the cleaning device has a vibration cleaning function, and the cleaning cloth comprises:
a cleaning layer, comprising a fixed area and a plurality of movable areas, wherein the plurality of movable areas are distributed in a front-rear direction of the cleaning device.

2. The cleaning cloth according to claim 1, wherein, in two adjacent movable areas, an area of a movable area close to a forward direction of the cleaning device is larger than an area of a movable area away from the forward direction.

3. The cleaning cloth according to claim 1, wherein the cleaning layer comprises two movable areas.

4. The cleaning cloth according to claim 1, wherein at least a part of the fixed area is located on a side of the plurality of movable areas close to a backward direction of the cleaning device.

5. The cleaning cloth according to claim 1, further comprising:
an adhesive layer, comprising a first adhesive part and second adhesive parts which are separated from one another, wherein the fixed area of the cleaning layer is attached to the cleaning device through the first adhesive part, and the plurality of movable areas of the cleaning layer are attached to the cleaning device through the second adhesive parts.

6. The cleaning cloth according to claim 5, wherein the adhesive layer comprises a plurality of separate second adhesive parts, and the plurality of second adhesive parts are located on the plurality of movable areas in one-to-one correspondence with the plurality of movable areas.

7. The cleaning cloth according to claim 5, wherein a surface of the adhesive layer attached to the cleaning device comprises a hook surface and/or a loop surface of a hook and loop fastener.

8. The cleaning cloth according to claims 1, wherein a material of the cleaning layer comprises polyester and chinlon, and a mass ratio of the polyester to the chinlon is 7:2-7:4.

9. The cleaning cloth according to claim 1, further comprising:
a guide strip, connected to the cleaning layer, wherein the guide strip is configured to fix the cleaning cloth.

10. A cleaning device, comprising:
a cleaning cloth; and
a wiping assembly, comprising a fixing plate and a plurality of vibration plates, wherein the fixed area of the cleaning cloth is located on the fixing plate, and the plurality of movable areas of the cleaning cloth are located on the plurality of vibration plates in one-to-one correspondence with the plurality of vibration plates,
wherein the cleaning cloth comprises:
a cleaning layer, comprising a fixed area and a plurality of movable areas, wherein the plurality of movable areas are distributed in a front-rear direction of the cleaning device.

11. The cleaning device according to claim 10, wherein, in two adjacent movable areas, an area of a movable area close to a forward direction of the cleaning device is larger than an area of a movable area away from the forward direction.

12. The cleaning device according to claim 10, wherein the cleaning layer comprises two moveable areas.

13. The cleaning device according to claim 10, wherein at least a part of the fixed area is located on a side of the plurality of movable areas close to a backward direction of the cleaning device.

14. The cleaning device according to claim 10, wherein the cleaning cloth further comprises: an adhesive layer, comprising a first adhesive part and second adhesive parts which are separated from one another, wherein the fixed area of the cleaning layer is attached to the cleaning device through the first adhesive part, and the plurality of movable areas of the cleaning layer are attached to the cleaning device through the second adhesive parts.

15. The cleaning device according to claim 14, wherein the adhesive layer comprises a plurality of separate second adhesive parts, and the plurality of second adhesive parts are located on the plurality of movable areas in one-to-one correspondence with the plurality of movable areas.

16. The cleaning device according to claim 14, wherein a surface of the adhesive layer attached to the cleaning device comprises a hook surface and/or a loop surface of a hook and loop fastener.

17. The cleaning device according to claim 10, wherein a material of the cleaning layer comprises polyester and chinlon, and a mass ration of the polyester to the chinlon is 7:2-7:4.

18. The cleaning device according to claim 10, wherein the cleaning cloth further comprises: a guide strip, connected to the cleaning layer, wherein the guide strip configures to fix the cleaning cloth.
